(19) United States
(12) Patent Application Publication
(10) Pub. No.: US 2023/0065834 A1
(43) Pub. Date: Mar. 2, 2023

(54) BEHAVIOR ANALYSIS DEVICE AND BEHAVIOR ANALYSIS METHOD

(71) Applicant: OMRON Corporation, Kyoto-shi, KYOTO (JP)

(72) Inventor: Takashi OHTA, Kyoto-shi, KYOTO (JP)

(21) Appl. No.: 17/793,479

(22) PCT Filed: Dec. 16, 2020
(86) PCT No.: PCT/JP2020/047060

§ 371 Date: Jul. 18, 2022

(30) Foreign Application Priority Data
Feb. 21, 2020 (JP) 2020-028092

(51) Int. Cl. G06Q 10/06; G06T 7/20; G06V 40/16

(52) U.S. Cl. CPC G06Q 10/063112; G06T 7/20; G06V 40/172

(57) ABSTRACT

A movement analysis device includes an obtainer that obtains positional information about a person performing predetermined movement within a predetermined area, a data accumulator that stores time-series data about the positional information obtained by the obtainer, and a data analyzer that analyzes a cyclical pattern of changes in the positional information based on the time-series data to generate a model representing an average change in the positional information in one cycle.

### FIELD

The present invention relates to a technique for analyzing the movement of a person.

### BACKGROUND

Productivity is to be improved at production sites. At production sites involving many manual operations and complicated operations performed by workers, such as at a production site incorporating a cellular manufacturing system, the operations may be performed by workers in different manners and with different movements, thus varying the work efficiency of each worker. Excess motions of workers or operational portions that are likely to involve delays or errors may be identified and corrected to improve the processes and operations. However, supervisors or skilled workers have simply monitored other workers and identified their excess motions or operational portions that are likely to involve delays or errors. Improving the processes and operations has thus been time-consuming as well as involved a high skill level.

Patent Literature 1 describes a method for assisting workers with a system that allows easy retrieval of knowledge and experiences of skilled workers. However, simply providing such a system is insufficient to improve work efficiency and processes.

### CITATION LIST

### Patent Literature

Patent Literature 1: Japanese Unexamined Patent Application Publication No. 2007-148938

### SUMMARY

### Technical Problem

In response to the above issue, one or more aspects of the present invention are directed to a technique for assisting in monitoring the movement of a person and identifying portions to be improved.

### Solution to Problem

A movement analysis device according to an aspect of the present disclosure includes an obtainer that obtains positional information about a person performing predetermined movement within a predetermined area, a data accumulator that stores time-series data about the positional information obtained by the obtainer, and a data analyzer that analyzes a cyclical pattern of changes in the positional information based on the time-series data to generate a model representing an average change in the positional information in one cycle.

The movement analysis device with this structure can automatically generate a model that represents the tendency of movement of a person (changes in the positional information). The model can have various uses in, for example, comparing differences in movement between persons, determining the characteristics of the movement (e.g., favorable portions, unfavorable portions, and excess motions) of each person, and identifying portions to be improved in a predetermined area or in predetermined movement.

The movement analysis device may further include an evaluator that compares positional information obtained in one cycle with the model to detect unusual movement. The movement analysis device with this structure can detect any unusual movement of a person and is thus useful for monitoring the movement of a person. For example, the evaluator may determine that movement is unusual in response to at least a difference in positional information at a time point or a difference in a length of one cycle exceeding a predetermined threshold between the obtained positional information in one cycle and the model. This allows detection of unusual movement through a simple process. The movement analysis device may further include an output unit that provides a notification in response to detection of unusual movement.

The data accumulator may store time-series data about one or more persons. The data analyzer may analyze a cyclical pattern of changes in positional information about each of the one or more persons to generate a model for each of the one or more persons. This allows determination of the tendency of each person that differs depending on each person. The evaluator may compare the positional information in one cycle and the model for each of the one or more persons. This allows accurate detection of unusual movement of each person.

The movement analysis device may further include an evaluator that relatively evaluates a plurality of models generated based on time-series data about a plurality of persons and determines a skill level for the predetermined movement of each of the plurality of persons. The movement analysis device with this structure can automatically and easily determine the skill level of each person. The evaluator may further select, based on the determined skill level of each of the plurality of persons, a model of a skilled person from the plurality of models and compare a model of an evaluation target person and the model of the skilled person. Such a comparison allows evaluation as to whether the movement of the evaluation target person is favorable and allows detection of portions to be improved in the movement of the evaluation target person. For example, the movement analysis device may further include an output unit that outputs information indicating a difference between the model of the evaluation target person and the model of the skilled person. For example, such information may be provided to an administrator or a supervisor, thus assisting in identifying portions to be improved or in improving processes.

The evaluator may relatively evaluate a time length of each of the plurality of models and determine the skill level of each of the plurality of persons. This allows determination of the skill level through a simple process. When, for example, the predetermined movement is a task including one or more processes, the evaluator may calculate an operation time of each of the one or more processes based on each of the plurality of models, and perform sorting based on a length of the operation time in each of the one or more processes to determine a skill level for each of the one or more processes of each of the plurality of persons. This allows evaluation or determination of portions to be improved for each process.

The obtainer may obtain, based on information received from a sensor sensing a person in the predetermined area, the positional information about the person. The sensor may be, for example, an image sensor, a motion detector, or a sensor to detect a position of a person in combination with a device carried by the person. The obtainer may identify a person performing the predetermined movement based on facial recognition. The obtainer may externally obtain identification information to identify a person performing the predetermined movement.

One or more aspects of the present invention may be directed to a movement analysis device including at least one of the above elements, or to, for example, a movement evaluation device, a movement monitoring device, an abnormality detection device, a skill level evaluation device, or a process improvement assisting device. One or more aspects of the present invention may be directed to, for example, a movement analysis method, a movement evaluation method, a movement monitoring method, an abnormality detection method, a skill level evaluation method, or a process improvement assisting method each including at least one of the above processes. One or more aspects of the present invention may be directed to a program for causing a processor to perform the steps included in the method, or a non-transitory computer-readable storage medium storing the program. The above elements and processes may be combined with one another in any manner to form one or more aspects of the present invention.

### Advantageous Effects

The technique according to the above aspects of the present invention assists in monitoring the movement of a person and identifying portions to be improved.

### BRIEF DESCRIPTION OF THE DRAWINGS

FIG. 1 is a diagram showing an example of movement analysis of workers on a production line.

FIG. 2 is a block diagram of a monitoring system including a movement analysis device.

FIG. 3 is a flowchart of data analysis and model generation performed by the movement analysis device.

FIG. 4 is a schematic diagram describing data analysis and model generation.

FIG. 5 is a flowchart of abnormality detection performed by the movement analysis device.

FIG. 6 is a schematic diagram describing the abnormality detection.

FIG. 7 is a flowchart of skill level determination performed by the movement analysis device.

FIG. 8 is a schematic diagram describing the skill level determination.

FIG. 9 is a flowchart of model comparison performed by the movement analysis device.

### DETAILED DESCRIPTION

### Example Use

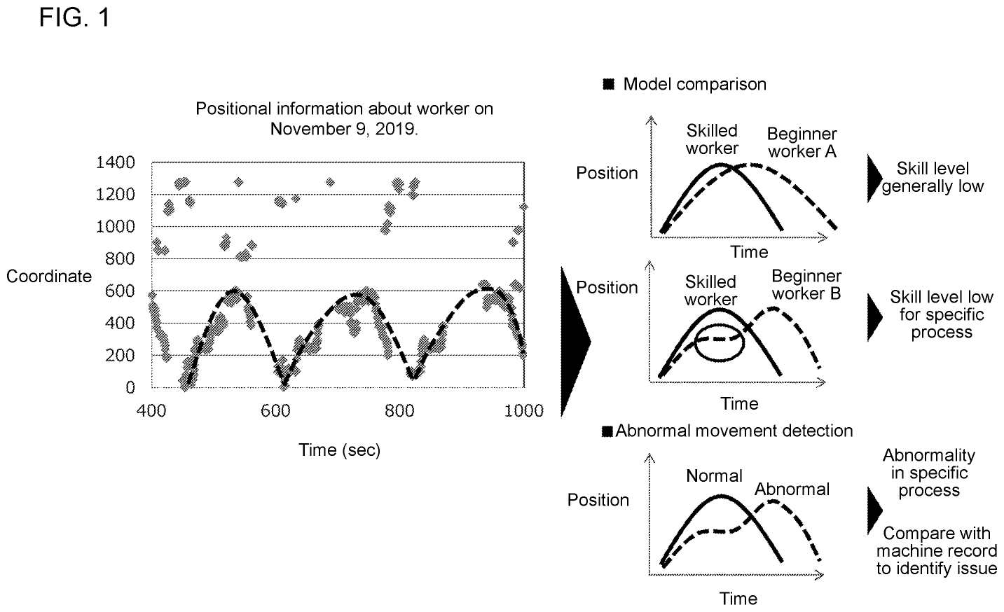

The movement analysis of workers on a production line will now be described with reference to FIG. 1 as an example use of the present invention.

On a production line incorporating, for example, a cellular manufacturing system, a worker sequentially performs multiple operational processes while moving within a predetermined work area. The worker performs operations in accordance with a predetermined procedure, and thus the movement can be partially cyclical and regular. For example, in the graph in the left portion of FIG. 1, temporal changes in the positional information about a worker is plotted (the horizontal axis indicates time, and the vertical axis indicates position coordinates). As shown in the graph, the changes in the positional information show a cyclical pattern (indicated by a dashed line). The method according to one or more embodiments of the present invention generates a model that represents an average change in the positional information about a worker in one cycle by analyzing the cyclical pattern of changes in the positional information based on time-series data. The model represents the statistical tendency of the worker's movement, or in other words, the routine movement of the worker.

Such a model can be used for, for example, visualization of the tendency of a worker, determination or detection of an abnormal motion (unusual movement), evaluation of the skill level for operation, and comparison of the motions of different workers. An example use of the model is shown in the right portion of FIG. 1. For example, the comparison between a model for a skilled worker and a model for a beginner worker A shows that the patterns for these workers are substantially the same but the pattern for the beginner worker A is horizontally elongated (or with a longer cycle), revealing that the beginner worker A has an overall lower skill level for operation. The comparison between the model for the skilled worker and a model for a beginner worker B shows that the beginner worker B has a lower skill level for operation at position X. The comparison between the movement of a worker that is constantly updated with the movement specified by the model allows determination or detection of any abnormal motion of the worker. An abnormal motion detected frequently at the same position (or process) may suggest that the process has an issue. For example, the result may be used to review the record of the machine used in the process and to identify an abnormality or a failure of the machine or to improve the work procedure in the process.

### Embodiments

(Monitoring System Configuration)

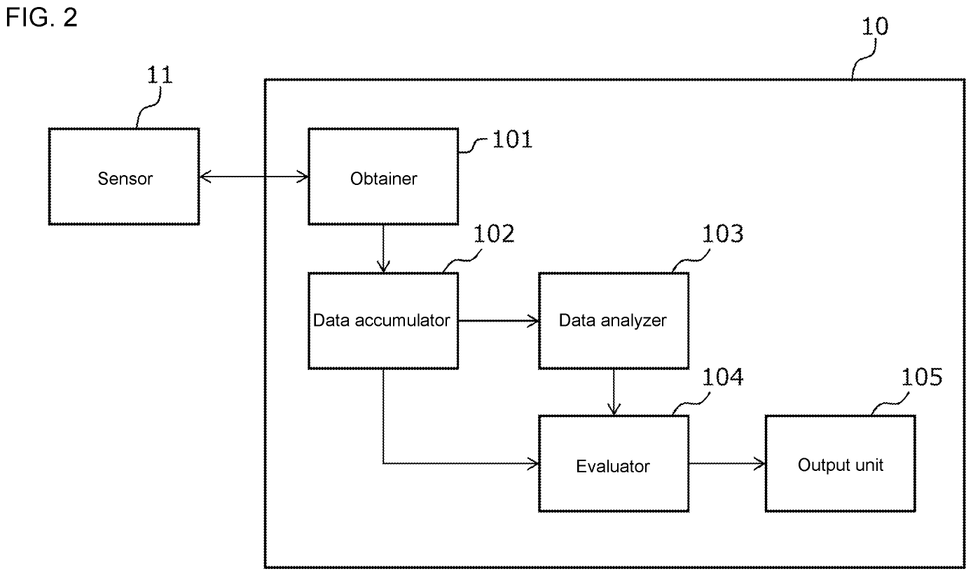

A movement analysis device according to an embodiment of the present invention will now be described with reference to FIG. 2. FIG. 2 is a block diagram of a monitoring system including the movement analysis device.

A monitoring system 1 monitors the operational situation of a worker on a production line at a factory. The monitoring system 1 mainly includes a movement analysis device 10 and a sensor 11. The movement analysis device 10 and the sensor 11 may each have any structure. For example, the movement analysis device 10 and the sensor 11 may be connected with each other with wires or wirelessly to allow communication between them, or may be integral with each other (more specifically, the movement analysis device 10 and the sensor 11 are incorporated in a single housing). For the connected structure, the correspondence between the number of movement analysis devices 10 and the number of sensors 11 is not limited to one to one, and may be one to N, N to one, or N to N (N is an integer greater than or equal to 2). For the integral structure, the control of the sensor 11 and the functions of the movement analysis device 10 may be implemented using the same processor.

(Sensor)

The sensor 11 senses the position of a worker on the production line. The sensor 11 can be any type of sensor that can sense the position of a worker. For example, the sensor 11 may be an image sensor that captures an image of an area in which a worker moves or may be a motion detector that detects the position of a worker in an area in which the worker moves. Examples of the motion detector include an infrared sensor and a radio frequency sensor. The sensor 11 may detect the position of a worker in combination with a device (e.g., a tag, a smartphone, a Bluetooth Low Energy or BLE device, or a transmitter) carried by the worker. A sensing result from the sensor 11 is constantly updated by the movement analysis device 10.

In the present embodiment, the sensor 11 is an image sensor. A single image sensor can monitor a wide area, can simultaneously obtain the positional information about multiple workers, and can measure the positional information with high accuracy. The image sensor includes a camera with a wide field of view (e.g., a fisheye camera or a 360-degree camera) and an image processor for processing an image captured by the camera. For example, the image processor may detect a human face or a human body from the image, may track the detected human face or the detected human body, and may identify (determine) individuals using facial recognition or human body recognition. The image processor includes, for example, a processor and a memory. The processor reads and executes a program stored in the memory to implement the functions described above. The functions described above may be entirely or partly implemented by a processor such as an application-specific integrated circuit (ASIC) or a field-programmable gate array (FPGA).

(Movement Analysis Device)

The movement analysis device 10 performs movement analysis of a worker working on the production line using the sensing result received from the sensor 11. The movement analysis device 10 according to the present embodiment mainly includes an obtainer 101, a data accumulator 102, a data analyzer 103, an evaluator 104, and an output unit 105. The movement analysis device 10 may be a general-purpose computer including, for example, a central processing unit (CPU, or processor), a read-only memory (ROM), a random-access memory (RAM), a storage (e.g., a hard disk drive or HDD, or a solid state drive or SSD), an input device (e.g., a keyboard or a pointing device), and a display. In this case, the components 101 to 105 shown in FIG. 2 are implemented by the processor reading and executing the program stored in the ROM or the storage. The components 101 to 105 may be entirely or partly implemented by a processor such as an ASIC or an FPGA. The functions of the movement analysis device 10 may be implemented by cloud computing or distributed computing.

The obtainer 101 obtains data about the sensing result from the sensor 11. The sensing result includes, for example, the positional information about a detected worker and time information indicating the time of detection. The sensing result may include information other than the positional information and the time information such as a worker identification (ID) (identification information identifying a worker) and a production line number. The positional information includes, for example, coordinate values that define the position of the worker. The coordinate system for the positional information may be a sensor coordinate system or a global coordinate system. A two-dimensional coordinate system that defines a position in a plane may be used. A one-dimensional coordinate system may be used for a worker determined to move in a simple reciprocating manner. In the present embodiment, the sensor 11 (image sensor) determines the positional information about a worker. In some embodiments, the obtainer 101 may receive raw data from the sensor 11 (image data from the image sensor) and analyze the raw data (detect a face or a human body in the image data) to recognize the positional information about the worker. The obtainer 101 may identify a worker from the image data using, for example, facial recognition technology. The obtainer 101 may externally receive the identification information about a worker in addition to the sensing result. For example, the obtainer 101 may receive identification information read from the ID card carried by a worker together with time information and associate the worker with the positional information based on the time information. A user (an operator of the movement analysis device 10) may manually input the worker ID.

The data accumulator 102 stores time-series data about the sensing result obtained by the obtainer 101 into a nonvolatile storage. FIG. 2 schematically shows example time-series data being stored. In the example in FIG. 2, the production line number, the positional information, and the date and time of detection are stored for each worker ID.

The data analyzer 103 analyzes a cyclical pattern of changes in the positional information based on the time-series data to generate a model that represents an average change in the positional information in one cycle. The data analyzer 103 analyzes the time-series data about each worker and generates a model for each worker. More specifically, the data analyzer 103 generates a model that represents the statistical tendency of the movement (routine movement) of each worker.

The evaluator 104 compares the positional information in one cycle that is newly obtained by the obtainer 101 with the model generated by the data analyzer 103 to detect any unusual movement. Additionally, the evaluator 104 relatively evaluates multiple models generated based on the time-series data about multiple workers to determine the skill level of each worker or compares the models (tendencies of movement) of a skilled worker and an unskilled worker.

The output unit 105 outputs the information obtained by the data analyzer 103 and the evaluator 104. The output unit 105 may output the information on a display included in the movement analysis device 10, or may transmit the information to an external device. For example, the output unit 105 may transmit a notification message to a terminal owned by an administrator or a supervisor, may transmit a warning signal or a control signal to another device, or may produce sound, emit light, or generate vibration.

(Model Generation)

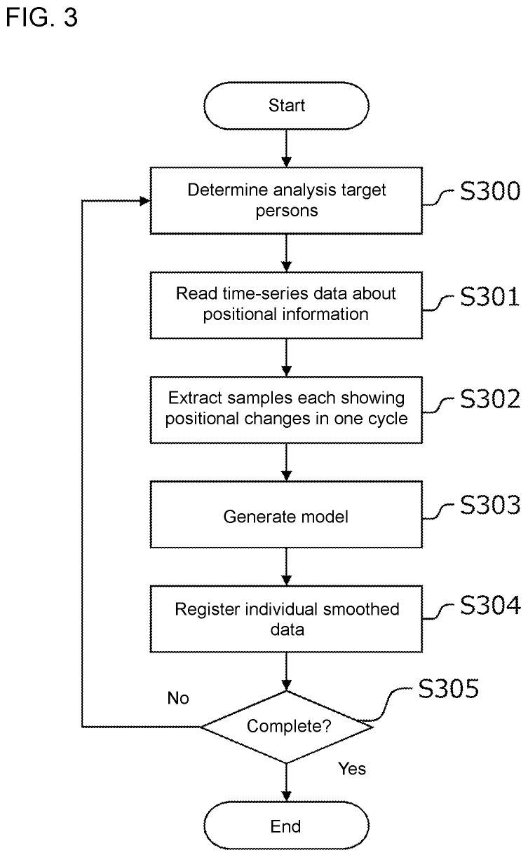

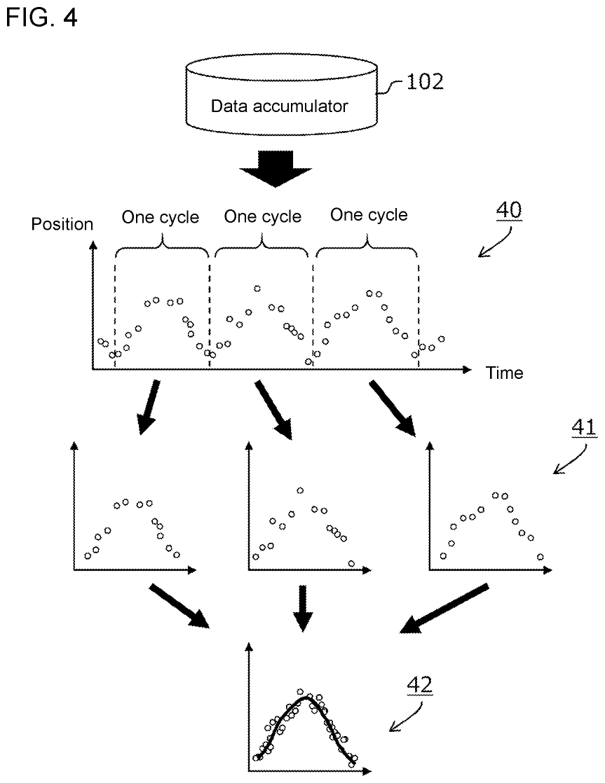

An example process of data analysis and model generation will now be described with reference to FIGS. 3 and 4. FIG. 3 is a flowchart of data analysis and model generation performed by the movement analysis device 10. FIG. 4 is a schematic diagram describing data analysis and model generation. The process in FIG. 3 may be performed with a statistically sufficient amount of time-series data stored in the data accumulator 102.

In step S300, the data analyzer 103 determines analysis target persons. For example, when the data accumulator 102 stores data about multiple workers, the data analyzer 103 may select analysis target persons in the order of their worker IDs. The user may specify analysis target persons. The processing in subsequent steps S301 to S304 is performed for each analysis target person.

In step S301, the data analyzer 103 reads, from the data accumulator 102, time-series data 40 about the positional information about the analysis target person.

In step S302, the data analyzer 103 divides the time-series data about the positional information per cycle and extracts multiple samples 41 each showing changes in the positional information in one cycle. The start point and the end point of one cycle may be determined from peaks (maximum or minimum) in the time-series data about the positional information or may be determined based on values of the positional information. For a task including n operational processes, or processes 1 to n, for example, the worker repeats the processes 1 to n. In this case, the single cycle may be determined to end (and a sequent cycle may be determined to start) when the value of the positional information about the worker falls within the range corresponding to an operational position to perform the process 1.

In step S303, the data analyzer 103 generates a model 42 that represents an average change in the positional information in one cycle using the multiple samples 41 extracted in step S302. For example, the data analyzer 103 may generate the model by fitting, with, for example, the least squares method, a curve to data points plotted with positional information for the multiple samples obtained with the same phase or a time point. In some embodiments, the data analyzer 103 may calculate average values of positional information for the same phase (time point) for the multiple samples and generate the model using a sequence of points representing the average values (or a curve fitted to the sequence of points). The data analyzer 103 may generate the model with a method other than the methods described herein. The data analyzer 103 may use all the samples extracted in step S302 or may selectively use samples with substantially the same cycle length for model generation.

In step S304, the data analyzer 103 registers the model 42 generated in step S303 with the data accumulator 102 together with information about the worker ID of the analysis target person and the period of the time-series data used for data analysis. The data registered in step S304 will be hereafter referred to as individual smoothed data, or data that defines the routine (reference) movement of an individual worker. For a single worker, multiple sets of individual smoothed data resulting from the time-series data with different periods may be registered with the data accumulator 102. A worker can acquire a higher skill level for operation over time to undergo changes in the movement.

In step S305, the data analyzer 103 determines whether the processing for all the workers is complete. When any processing is incomplete, the data analyzer 103 returns to step S301 to perform data analysis of the next worker.

(Abnormality Detection)

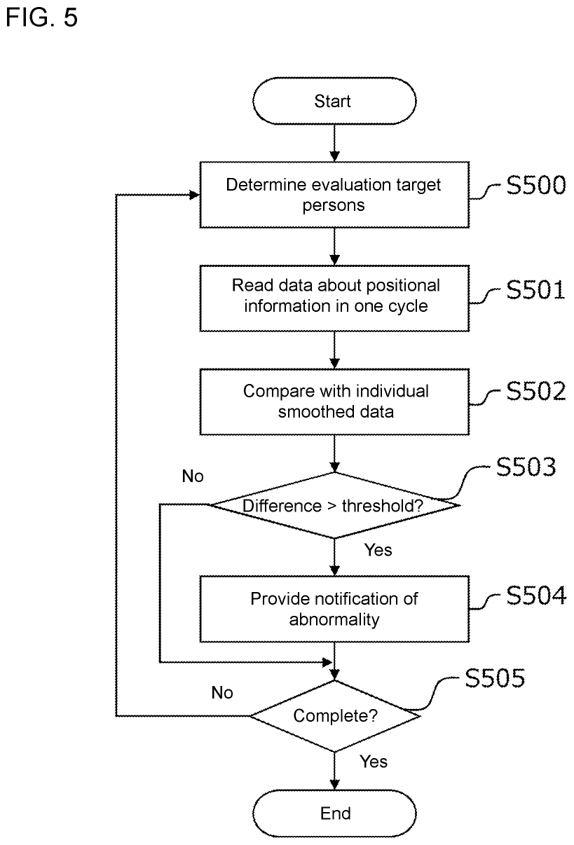

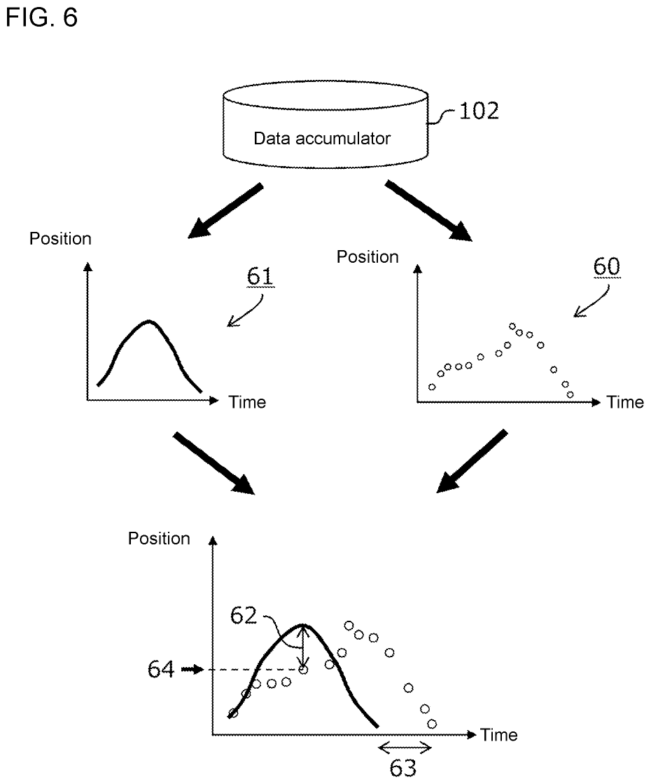

An example process of abnormality detection will now be described with reference to FIGS. 5 and 6. FIG. 5 is a flowchart of abnormality detection performed by the movement analysis device 10. FIG. 6 is a schematic diagram describing the abnormality detection. The process in FIG. 5 can be performed after the individual smoothed data is generated and registered. The process in FIG. 5 may be performed online (on the data being constantly received from the sensor 11 while the production line is running), or may be performed offline (for later evaluation of the data stored in, for example, the data accumulator 102). The process performed online will now be described.

In step S500, the evaluator 104 determines evaluation target persons. For example, when the data accumulator 102 stores individual smoothed data about multiple workers registered, the evaluator 104 may select evaluation target persons in the order of their worker IDs. The user may specify evaluation target persons. The processing in subsequent steps S501 to S504 is performed for each evaluation target person.

In step S501, the evaluator 104 reads, from the data accumulator 102, data about the positional information 60 in an immediately preceding cycle about the evaluation target person. The start point and the end point of one cycle may be determined in the same manner as described in step S302. The evaluator 104 may fit a curve to a sequence of points representing positional information in one cycle.

In step S502, the evaluator 104 reads, from the data accumulator 102, individual smoothed data 61 about the evaluation target person and compares the positional information 60 in one cycle obtained in step S501 with the individual smoothed data 61. For example, the evaluator 104 may calculate a difference 62 in the value of the positional information at a time point (phase) or a difference 63 in the length of one cycle between the obtained positional information 60 in one cycle and the individual smoothed data 61. When the difference 62 or the difference 63 exceeds a predetermined threshold (Yes in step S503), the output unit 105 provides a notification indicating that an abnormality (unusual movement of the evaluation target person) has been detected (step S504). The output unit 105 may provide information about the operation line and the operational process with the abnormality in addition to the notification of the abnormality. The operational process with the abnormality can be estimated from, for example, a point 64 at which the positional information 60 in one cycle deviates most from the individual smoothed data 61.

In step S505, the evaluator 104 determines whether the processing for all the workers is complete. When any processing is incomplete, the evaluator 104 returns to step S501 to evaluate the next worker.

(Skill Level Determination)

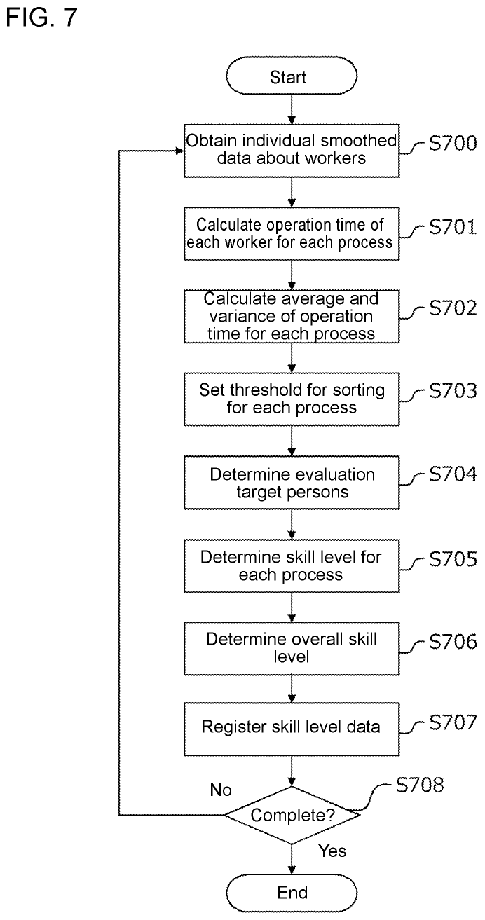

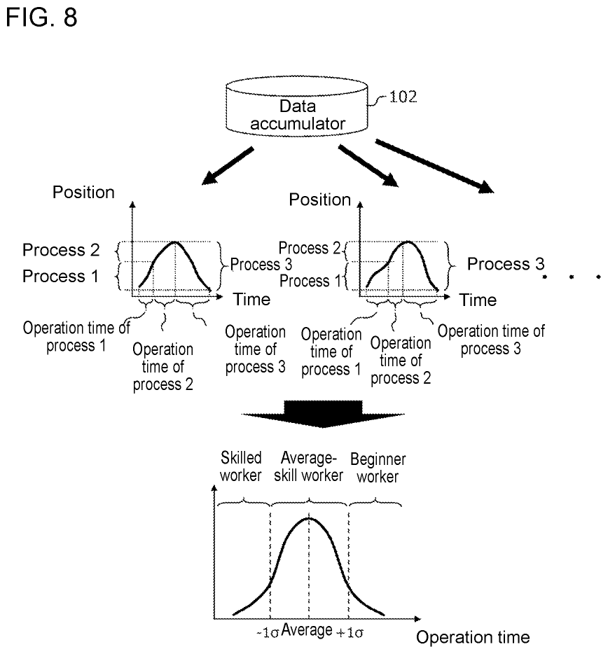

An example process of skill level determination will now be described with reference to FIGS. 7 and 8. FIG. 7 is a flowchart of skill level determination performed by the movement analysis device 10. FIG. 8 is a schematic diagram describing the skill level determination. The process in FIG. 7 can be performed after individual smoothed data about multiple workers is generated and registered. In the present embodiment, the skill levels of workers are determined by relatively evaluating individual smoothed data about multiple workers.

In step S700, the evaluator 104 obtains, from the data accumulator 102, individual smoothed data about multiple workers. In step S701, the evaluator 104 calculates the operation time of each process based on the individual smoothed data. The correspondence between the value of the positional information and the operational position for each process is known. Thus, the start point and the end point of each process can be determined based on the values of the positional information as shown in FIG. 8.

In step S702, the evaluator 104 calculates an average and a variance of the operation time for each process based on the data about the multiple workers. In step S703, the evaluator 104 sets, for each process, a threshold for sorting the workers based on their skill levels. For example, as shown in FIG. 8, the workers may be sorted into one of three classes, or classes of a skilled worker, an average-skill worker, and a beginner worker. A worker with an operation time shorter than the average−1σ (σ is a standard deviation) is sorted into the class of the skilled worker, a worker with an operation time within a range from the average−1σ to the average+1σ is sorted into the class of the average-skill worker, and a worker with an operation time longer than the average+1σ is sorted into the class of the beginner worker. The method for setting the thresholds and the number of classes are not limited to the above example, and may be designed as appropriate.

In step S704, the evaluator 104 determines evaluation target persons. For example, the evaluator 104 may select evaluation target persons in the order of their worker IDs. The user may specify evaluation target persons. In step S705, the evaluator 104 calculates the operation time of each process based on the individual smoothed data about the evaluation target person (when the operation time is calculated in step S701, the calculation results may be used) and compares the operation time with the threshold set in step S703 to determine the skill level for each process. In the present embodiment, for example, the skill level for each process is set to 2 (skilled worker), 1 (average-skill worker), and 0 (beginner worker). In step S706, the evaluator 104 adds up the skill levels for the processes to calculate an overall skill level. For example, with three processes involved, a minimum score value of the overall skill level is 0 when the skill levels for the processes are all 0 (beginner worker), and a maximum score value is 6 when the skill levels for the processes are all 2 (skilled worker).

In step S707, the evaluator 104 registers data about the skill level for each process calculated in step S705 and the overall skill level calculated in step S706 both with the data accumulator 102 together with information about the worker ID of the evaluation target person and the period of the individual smoothed data used for evaluation. The data registered in step S707 will be hereafter referred to as skill level data. For a single worker, multiple sets of skill level data resulting from the individual smoothed data with different periods may be registered with the data accumulator 102. A worker can increase the skill level over time.

In step S708, the evaluator 104 determines whether the processing for all the workers is complete. When any processing is incomplete, the evaluator 104 returns to step S704 to calculate the skill level of the next worker.

(Comparison with Skilled Worker)

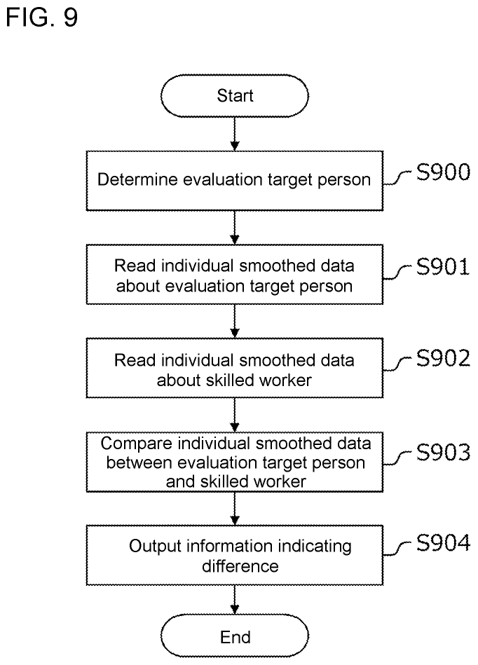

An example process of model comparison with a skilled worker will now be described with reference to FIG. 9. FIG. 9 is a flowchart of model comparison performed by the movement analysis device 10. The process in FIG. 9 can be performed after individual smoothed data and skill level data are generated and registered.

In step S900, the evaluator 104 determines an evaluation target person. For example, the user may specify an evaluation target person, or the evaluator 104 may automatically select an evaluation target person. In step S901, the evaluator 104 reads, from the data accumulator 102, individual smoothed data about the evaluation target person.

In step S902, the evaluator 104 selects one skilled worker based on the skill level data and reads individual smoothed data about the skilled worker from the data accumulator 102. For example, the evaluator 104 may select a worker with the highest overall skill level as a skilled worker. With the focus on a specific process, the evaluator 104 may select a worker with both a high skill level for the process and a high overall skill level as a skilled worker.

In step S903, the evaluator 104 compares the individual smoothed data about the evaluation target person and the individual smoothed data about the skilled worker. In step S904, the output unit 105 outputs information indicating a difference between the individual smoothed data about the evaluation target person and the individual smoothed data about the skilled worker. For example, as shown in the right portion of FIG. 1, the individual smoothed data about the evaluation target person and the individual smoothed data about the skilled worker may be displayed to be superimposed on each other on the time axis. The output unit 105 may output information indicating, for example, a difference in the operation time of each process, a difference in the entire operation time, or a process with the largest difference in the operation time.

(Advantageous Effects of Present Embodiment)

The device according to the present embodiment described above can automatically generate individual smoothed data as a model that represents the tendency of movement of a person (changes in the positional information). The individual smoothed data has various uses in, for example, comparing differences in movement between persons, determining the characteristics of movement (e.g., favorable portions, unfavorable portions, and excess motions) of each person, and identifying portions to be improved in a predetermined area or in predetermined movement. The device can also automatically detect any unusual movement of a person and is thus useful for monitoring the movement of a person. The device can automatically and easily determine the skill level of each person. The device can also compare an evaluation target person with a skilled person to evaluate as to whether the movement of the evaluation target person is favorable or to detect portions to be improved in the movement of the evaluation target person. For example, such information may be provided to an administrator or a supervisor, thus assisting in identifying portions to be improved or in improving processes.

### Others

The embodiment described above is a mere example of the present invention. The present invention is not limited to the specific embodiment described above, but may be modified variously within the scope of the technical ideas of the invention. For example, although movement of a worker on a production line is analyzed and evaluated in the above embodiment, the present invention may be used for other targets and applications. Any predetermined movement that is to be performed by a person within a predetermined area can be another target. For example, the present invention can be used for analyzing movement of passersby at ticket gates at a station or a gate at a facility.

### Appendix 1

(1) A movement analysis device (10), comprising:

an obtainer (101) configured to obtain positional information about a person performing predetermined movement within a predetermined area;

a data accumulator (102) configured to store time-series data about the positional information obtained by the obtainer (101); and

a data analyzer (103) configured to analyze a cyclical pattern of changes in the positional information based on the time-series data to generate a model representing an average change in the positional information in one cycle.

### REFERENCE SIGNS LIST

1: Monitoring system

10: Movement analysis device

11: Sensor

1. A movement analysis device, comprising:
an obtainer configured to obtain positional information about a person performing predetermined movement within a predetermined area;
a data accumulator configured to store time-series data about the positional information obtained by the obtainer; and
a data analyzer configured to analyze a cyclical pattern of changes in the positional information based on the time-series data to generate a model representing an average change in the positional information in one cycle.

2. The movement analysis device according to claim 1, further comprising:
an evaluator configured to compare positional information obtained in one cycle with the model to detect unusual movement.

3. The movement analysis device according to claim 2, wherein
the evaluator determines that movement is unusual in response to at least a difference in positional information at a time point or a difference in a length of one cycle exceeding a predetermined threshold between the obtained positional information in one cycle and the model.

4. The movement analysis device according to claim 3, further comprising:
an output unit configured to provide a notification in response to detection of unusual movement.

5. The movement analysis device according to claim 4, wherein
the data accumulator stores time-series data about one or more persons,
the data analyzer analyzes a cyclical pattern of changes in positional information about each of the one or more persons to generate a model for each of the one or more persons, and
the evaluator compares the positional information in one cycle and the model for each of the one or more persons.

6. The movement analysis device according to claim 1, further comprising:
an evaluator configured to relatively evaluate a plurality of models generated based on time-series data about a plurality of persons and determine a skill level for the predetermined movement of each of the plurality of persons.

7. The movement analysis device according to claim 6, wherein
the evaluator further selects, based on the determined skill level of each of the plurality of persons, a model of a skilled person from the plurality of models and compares a model of an evaluation target person and the model of the skilled person.

8. The movement analysis device according to claim 7, further comprising:
an output unit configured to output information indicating a difference between the model of the evaluation target person and the model of the skilled person.

9. The movement analysis device according to claim 6, wherein
the evaluator relatively evaluates a time length of each of the plurality of models and determines the skill level of each of the plurality of persons.

10. The movement analysis device according to claim 6, wherein
the predetermined movement is a task including one or more processes, and
the evaluator calculates an operation time of each of the one or more processes based on each of the plurality of models, and performs sorting based on a length of the operation time in each of the one or more processes to determine a skill level for each of the one or more processes of each of the plurality of persons.

11. The movement analysis device according to claim 1, wherein
the obtainer obtains, based on information received from a sensor sensing a person in the predetermined area, the positional information about the person.

12. The movement analysis device according to claim 11, wherein
the sensor is an image sensor, a motion detector, or a sensor to detect a position of a person in combination with a device carried by the person.

13. The movement analysis device according to claim 1, wherein
the obtainer identifies a person performing the predetermined movement based on facial recognition.

14. The movement analysis device according to claim 1, wherein
the obtainer externally obtains identification information to identify a person performing the predetermined movement.

15. A movement analysis method, comprising:
obtaining positional information about a person performing predetermined movement in a predetermined area; and
analyzing a cyclical pattern of changes in the positional information based on stored time-series data about the positional information to generate a model representing an average change in the positional information in one cycle.

16. A non-transitory computer readable medium storing a program for causing a processor to perform a movement analysis method, comprising:
obtaining positional information about a person performing predetermined movement in a predetermined area; and
analyzing a cyclical pattern of changes in the positional information based on stored time-series data about the positional information to generate a model representing an average change in the positional information in one cycle.
